(19) United States
(12) Patent Application Publication
(10) Pub. No.: US 2021/0234501 A1
(43) Pub. Date: Jul. 29, 2021

(54) DUAL MOTOR SINGLE AXIS SOLAR TRACKER

(71) Applicant: Gamechange Solar Corp., Norwalk, CT (US)

(72) Inventors: Andrew Barron Worden, Redding, CT (US); Scott Van Pelt, Tarrytown, NY (US)

(73) Assignee: Gamechange Solar Corp., Norwalk, CT (US)

(21) Appl. No.: 17/155,601

(22) Filed: Jan. 22, 2021

Related U.S. Application Data
(60) Provisional application No. 62/965,744, filed on Jan. 24, 2020.

(51) Int. Cl. H02S 20/32; F24S 30/425

(52) U.S. Cl. CPC H02S 20/32; F24S 2030/115; F24S 30/425

(57) ABSTRACT

A single axis solar tracker includes two drive systems (motors) that both rotate a rotating shaft. The drive systems may be located about 16-25% from either longitudinal end of the rotating shaft.

### CROSS REFERENCE TO RELATED APPLICATIONS

This application claims the benefit of U.S. Provisional Patent Application Ser. No. 62/965,744 filed Jan. 24, 2020, which is hereby incorporated by reference.

### BACKGROUND OF THE INVENTION

### 1. Technical Field

This disclosure relates generally to a solar panel installation and, more particularly, to apparatuses and assemblies for use in a solar panel installation including a dual motor single axis solar tracker.

### 2. Background Information

Single axis solar trackers have been used to optimize photovoltaic module performance for several decades. However, as the size of solar power plants and the number of utility companies using solar to provide power to their customers has increased, the economics of how to best design a single axis tracker have changed dramatically in recent years. In particular, the number of photovoltaic modules that are supported on a single shaft has advanced rapidly from roughly 30 modules to up to about 180 modules. This has resulted in an increase in the length of the shaft and therefore an increase in the wind loads on the shaft.

The current state of the art is for the shaft to be rotated by a single motor at the middle of the tracker table, with the shaft extending out for roughly equal distances to the north and south of the motor. However, this results in several deleterious conditions.

The purpose of the single axis solar tracker is to orient the supported photovoltaic modules at the optimal angle to the light from the sun, thereby optimizing the energy output of the photovoltaic modules. However, it is difficult to ensure that all of the modules on the single axis solar tracker are at the same tilt angle due to a variety of factors including:
manufacturing tolerances of the shaft;
field installation tolerances of the shaft; and
the torsional loads of the self weight of the modules on the shaft which causes rotational deflection in the shaft.
   As conventional trackers only have one motor, and therefore only one point along the length of the shaft that is at a controlled angle, the issues identified above can cause significant numbers of photovoltaic modules along the length of the tracker to be at tilt angles that are unacceptably different from the optimal.

The long shafts extending out from the motor to the North and South are not supported rotationally along their entire length. As such, they are relatively flimsy with respect to torsional loads applied to them. This is of particular importance when designing the shafts to resist the wind loads that are applied to the tracker table. As shown through wind tunnel studies of multiple single axis trackers, the wind load does not act uniformly on the photovoltaic modules. The pressure gradient of the wind causes the modules to impart a torsional load on the shaft. This torsional load accumulates in the shaft and is maximum immediately adjacent to the drive system. A shorter shaft would accumulate less torsional load.

Potentially more influential in the design of the single axis tracker than the torsional load in the shaft is the aeroelastic stability of the tracker table. Aeroelastic instability is defined below. This phenomenon is closely tied to the modal frequency of the structure. The long unbraced length of the shaft of current trackers allows for relatively low modal frequencies and therefore low wind speeds at which aeroelastic instability can occur.

There is a need for an improved solar tracker.

### SUMMARY OF THE DISCLOSURE

Aspects of the disclosure are directed to an assembly for a solar panel installation, the assembly comprising a plurality of stationary structural members each having a length that extends longitudinally to an associated distal member end and a rotatable shaft having a rotatable axis and a rotatable shaft length L extending from a north end to a south end, wherein the rotatable shaft is rotatably connected to the plurality of stationary structural members at the distal member ends by one or more bearings. The assembly also includes a first drive mechanism configured to rotate the rotatable shaft about the rotatable axis at a first of the plurality of stational structural members, the first drive mechanism mounted to the first of the stationary structural members, and a second drive mechanism configured to rotate the rotatable shaft about the rotatable axis at a second of the plurality of stational structural members, the second drive mechanism mounted to the second of the stationary structural members.

The assembly may also comprise a first wind break plate mounted to the rotatable shaft, the first wind break plate configured to at least partially cover the distal member end of the first of the plurality of stationary members and the first drive mechanism, and a first wind break plate mounted to the rotatable shaft, the second wind break plate configured to at least partially cover the distal member end of the second of the plurality of stationary members and the second drive mechanism.

The first drive mechanism may be mounted about 16% of the rotatable shaft length L from the north end.

The second drive mechanism may be mounted about 16% of the rotatable shaft length L from the south end.

The first drive mechanism may be mounted less than about 16% of the rotatable shaft length L from the north end.

The second drive mechanism may be mounted less than about 16% of the rotatable shaft length L from the south end.

The first drive mechanism may be mounted about 25% of the rotatable shaft length L from the north end.

The second drive mechanism may be mounted about 25% of the rotatable shaft length L from the south end.

The first drive mechanism may be mounted less than about 25% of the rotatable shaft length L from the north end.

The second drive mechanism may be mounted less than about 16% of the rotatable shaft length L from the south end.

The first drive mechanism may be mounted about 20% of the rotatable shaft length L from the north end.

The second drive mechanism may be mounted about 20% of the rotatable shaft length L from the south end.

The first drive mechanism may be mounted less than about 20% of the rotatable shaft length L from the north end.

The second drive mechanism may be mounted less than about 16% of the rotatable shaft length L from the south end.

The assembly may further comprise a pair of purlin members, wherein the purlin members are located on opposing sides of the first of the plurality of stationary structural members along the rotational axis, and wherein the purlin members mount the first wind break plate to the rotatable shaft.

The assembly may further comprise a pair of solar panels, wherein the solar panels are located adjacent to the first wind break plate and mounted to the rotatable shaft, and wherein the wind first break plate substantially closes a gap between the solar panels.

The solar panel may be operable to provide power to the first drive mechanism.

The solar panel may be nested with an opening in the first wind break plate over the distal member end of the first of the plurality of stational structural members.

Aspects of the disclosure are also directed to an assembly for a solar panel installation, the assembly comprising a plurality of stationary structural members each having an length that extends longitudinally to a distal member end, each of the plurality of the stationary structural members comprising a first flange, a second flange and a web extending between the first flange and the second flange, and a rotatable shaft having a rotatable axis and a rotatable shaft length L extending from a north end to a south end, wherein the rotatable shaft is rotatably connected to each of the plurality of stationary structural members at the distal member ends by one or more bearings. The assembly also includes a first drive arm secured to the rotatable shaft and aligned with a first of the stationary structural members along the rotational axis, and a first actuator aligned with the first of the stationary structural members and the first drive arm along the rotational axis, the first actuator comprising a first actuator base and a first pushrod projecting out of the first actuator base, wherein the first actuator base is pivotally connected to and between the first and the second flanges with the first of the stationary structural members, wherein the first pushrod is pivotally connected to and between two mounts of the first drive arm, and wherein the first pushrod is configured to move into and out of the first actuator base in order to move the first drive arm relative to the first of the stationary structural members and thereby rotate the rotatable shaft about the rotational axis. The assembly further comprises a first second arm secured to the rotatable shaft and aligned with a second of the stationary structural members along the rotational axis; and a second actuator aligned with the second of the stationary structural members and the second drive arm along the rotational axis, the second actuator comprising a second actuator base and a second pushrod projecting out of the second actuator base, wherein the second actuator base is pivotally connected to and between the first and the second flanges with the second of the stationary structural members, wherein the second pushrod is pivotally connected to and between two mounts of the second drive arm, and wherein the second pushrod is configured to move into and out of the second actuator base in order to move the second drive arm relative to the second of the stationary structural members and thereby rotate the rotatable shaft about the rotational axis.

The first actuator may be mounted about 12-29% of the rotatable shaft length L from the north end of the rotatable shaft, and the second actuator may be mounted about 12-29% of the rotatable shaft length L from the south end of the rotatable shaft.

The first actuator may be mounted about 12-20% of the rotatable shaft length L from the north end of the rotatable shaft, and the second actuator may be mounted about 12-20% of the rotatable shaft length L from the south end of the rotatable shaft.

The foregoing features and the operation of the invention will become more apparent in light of the following description and the accompanying drawings.

### BRIEF DESCRIPTION OF THE DRAWINGS

FIG. 1 illustrates a solar panel installation;

FIG. 2 illustrates a first embodiment of a stationary structural member;

FIG. 3 illustrates a second embodiment of a stationary structural member;

FIGS. 4 and 5 illustrate an exemplary embodiment of a rotatable shaft;

FIG. 6 illustrates adjacent segments coupled together with a coupler;

FIG. 7 illustrates a bearing assembly are configured to rotatably mount the rotatable shaft;

FIG. 8 illustrates two adjacent bearing assemblies configured to rotatably mount the rotatable shaft;

FIG. 9 illustrates an exploded view of an embodiment of a bearing assembly;

FIG. 10 illustrates an exploded view of first and second segments of a bearing wheel of the bearing assembly;

FIG. 11 illustrates an exemplary embodiment of the drive mechanism;

FIG. 12 illustrates an exemplary embodiment of a wind break plate and support members operably positioned on the rotatable shaft;

FIG. 13 illustrates an exemplary embodiment of a wind break plate, support members and a solar panel operably positioned on the rotatable shaft;

FIGS. 14 and 15 illustrate an exemplary embodiment of a node controller with the rotatable shaft;

FIG. 16 illustrates a bearing assembly operably connected to the rotating shaft and the structural member and including one or more lateral capture devices;

FIG. 17 illustrates a portion of an alternative embodiment drive structure that includes a damper;

FIG. 18 illustrates a portion of yet another alternative embodiment drive structure that includes a first damper and a second damper; and

FIG. 19 illustrates a rotatable shaft of a single axis tracker that is rotatably secured to a plurality of stationary structural members and rotatably driven by dual motors.

### DETAILED DESCRIPTION

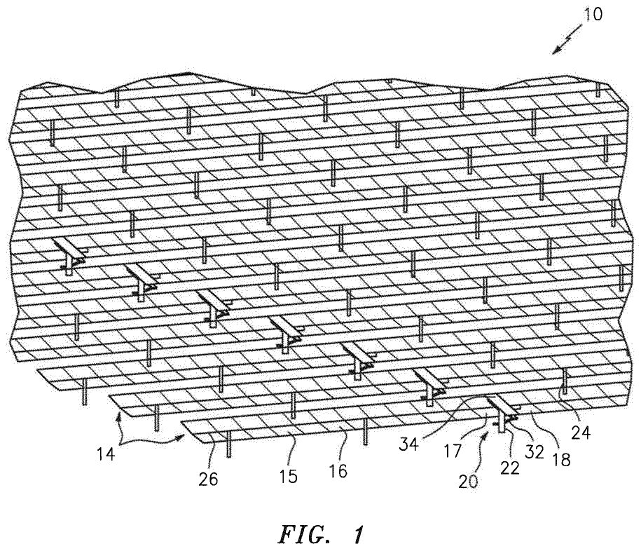

FIG. 1 illustrates a solar panel installation 10. An exemplary embodiment of such a solar panel installation is the Genius Tracker™ system designed by GameChange Solar of New York City, N.Y. Of course, the solar panel installation of the present disclosure is not limited to the specific exemplary. For examples, one or more of the Genius Tracker™ system components may be swapped out for components with alternate configurations, one or more the Genius Tracker™ system components may be omitted and/or the Genius Tracker™ system may be modified to include one or more additional components not specifically described herein.

Referring again to FIG. 1, the solar panel installation 10 includes one or more solar panel arrays 12, 14. Each of these solar panel arrays 12, 14 includes one or more solar panels 15-18 (e.g., a linear array of solar panels) mounted to a racking structure 20. Each racking structure 20 includes a plurality of stationary structural members 22, 24, a rotatable shaft 26, a plurality of bearing assemblies 28, 30 (see FIG. 5), and at least one drive mechanism 32. Each racking structure 20 may also include at least one wind break panel 34 for configuring with the drive mechanism 32.

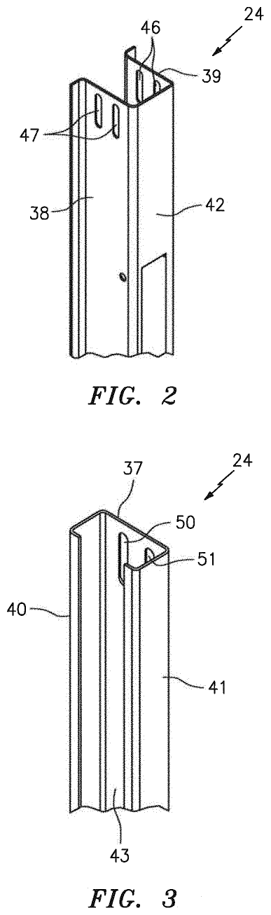

FIGS. 2 and 3 respectively illustrate exemplary embodiments of the stationary structural members 22, 24. The stationary structural member of FIG. 2 is configured as a center post, or drive mechanism support post. The stationary structural member of FIG. 3 is configured as a standard post, or support post. In some embodiments, one or more of the stationary structural members may be securely anchored to the ground. For example, a bottom portion of the member's length may be buried in the ground and/or otherwise secured to or with a foundation, which may be a driven pile, helical screw, screw, precast or cast in place concrete or any other foundation type. In other embodiments, one or more of the stationary structural members may be anchored to another structure such as, but not limited to, a building roof top.

Referring still to FIGS. 2 and 3, each stationary structural member has a length. This length extends longitudinally (e.g., substantially vertically when installed) from its bottom portion to a distal (e.g., top) member end 37. Each stationary structural member may include one or more flanges 38-41 and a central web 42, 43, which extends laterally (e.g., horizontally when installed) between the respective first and the second flanges. Each of the flanges 38, 39 of FIG. 2 includes one or more mounting apertures such as, but not limited to, a pair of longitudinal slots 46, 47. The web 43 of FIG. 3 similarly includes one or more mounting apertures such as, but not limited to, a pair of longitudinal slots 50, 51.

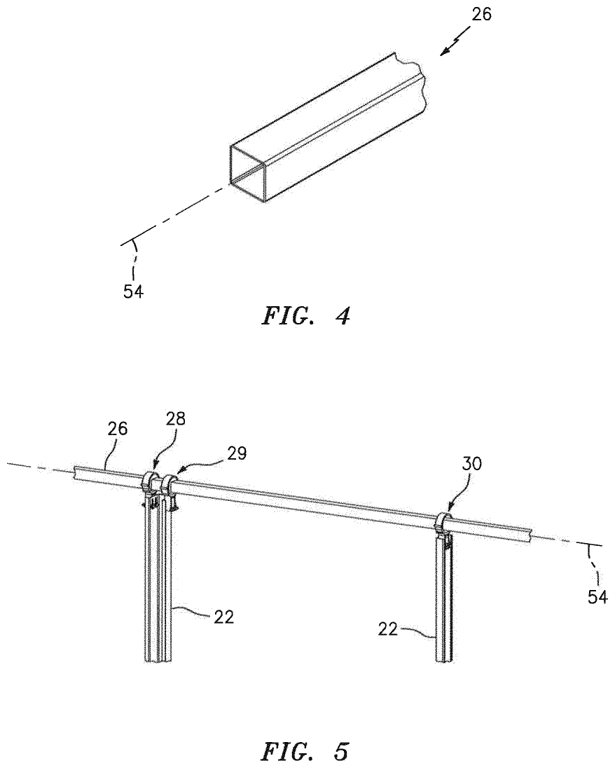

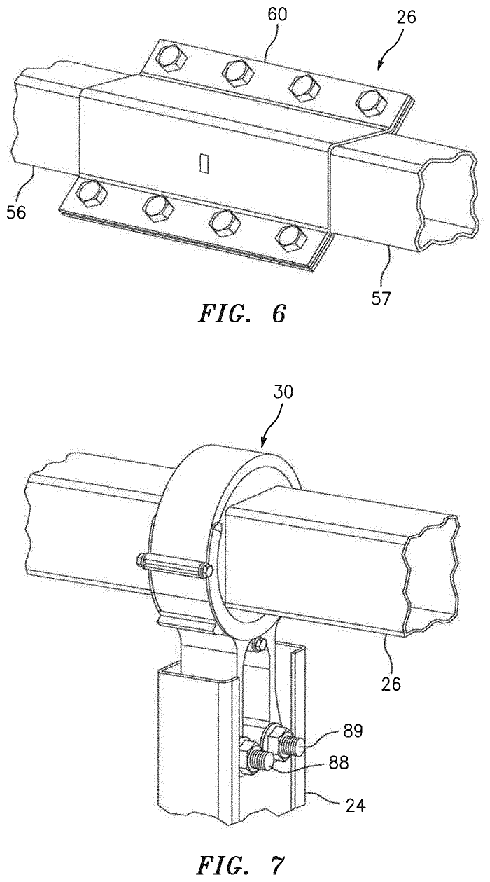

FIGS. 4 and 5 illustrate an exemplary embodiment of the rotatable shaft 26. The rotatable shaft has a length, which extends axially (e.g., substantially horizontally when installed) along a rotational axis 54. The rotatable shaft may be configured as a single length of shaft as shown in FIG. 5. Alternatively, the rotatable shaft 26 may be configured with a plurality of shaft segments 56, 57, where adjacent segments are coupled together with a coupler 60 (e.g., a clamping sleeve) as shown in FIG. 6 and/or otherwise connected to one another. The exemplary rotatable shaft of FIG. 4 has a polygonal (e.g., square) cross-sectional geometry; however, the rotatable shaft of the present disclosure is not limited to such a geometry.

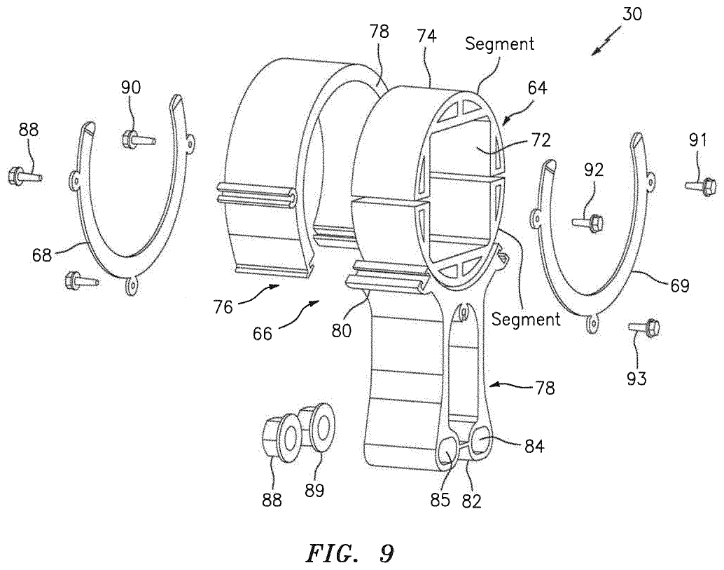

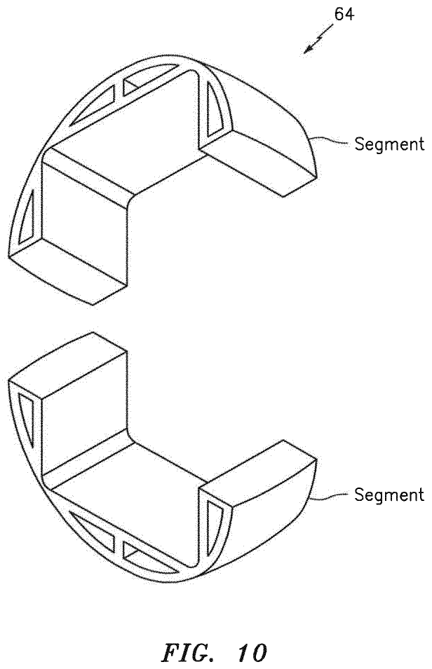

Referring to FIGS. 5, 7 and 8, bearing assemblies 28-30 are configured to rotatably mount the rotatable shaft 26 to the stationary structural members 22. Referring now to FIG. 9, each bearing assembly may include a bearing wheel 64, a bearing collar 66 and one or more capture rings 68-69.

Referring to FIG. 9, the bearing wheel 64 has a rotational axis, which is co-axial with the rotational axis 54 of the rotatable shaft 26 (see FIG. 5). The bearing wheel 64 includes and extends radially between an inner surface 72 and an outer surface 74. The inner surface 72 at least partially forms a bore. This bore extends axially through the bearing wheel 64 along the rotational axis 54. The bore may have a polygonal (e.g., square) cross-sectional geometry configured complementary to the geometry of the rotatable shaft. The bore may thereby receive the rotatable shaft axially therethrough. Of course, in other embodiments, the bore may be slightly larger than the rotatable shaft 26 and/or have a different geometry than that of the rotatable shaft where, for example, an intermediate element such as a bushing or a sleeve is disposed between the bearing wheel and the shaft. The outer surface 74 may have a circular cross-sectional geometry.

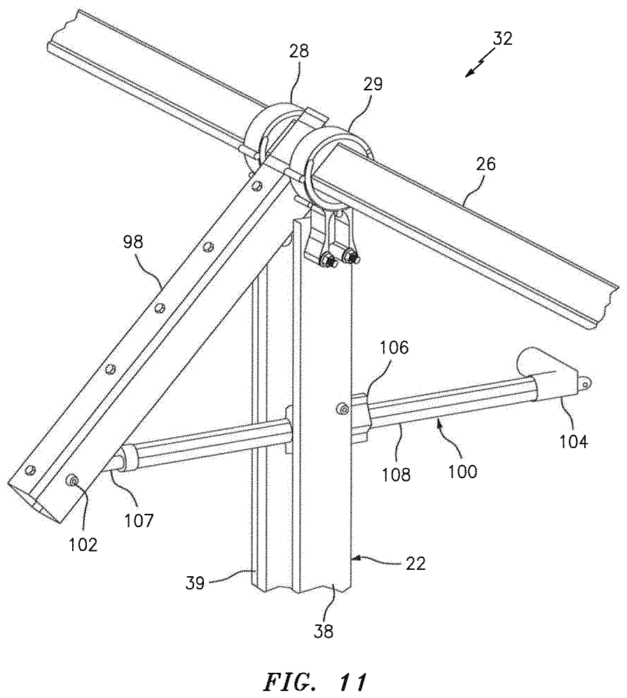

The bearing wheel 64 may be formed as a single, integral body. Alternatively, the bearing wheel may be formed from a plurality of discrete segments (e.g., discretely formed halves) as shown in FIGS. 9 and 10. These segments may be connected together, or not connected together; e.g., merely abutted against one another.

Referring again to FIG. 9, the bearing collar 66 may include a collar base 76 and a collar mount 78. The collar base 76 includes an inner surface 72 configured to circumscribe and slidingly engage the outer surface 74 of the bearing wheel 64. This collar base 76 may be formed as a single, integral body. Alternatively, the collar base 76 may be formed from a plurality of discrete segments secured together to form a hoop structure as shown in FIG. 9. The segments of FIG. 9, in particular, are secured together via locking tongue and groove (mortise) joints; however, other attachment methods and/or hardware may be used to secure the segments together.

In the exemplary embodiment of FIG. 9, bottom segment 80 extends between about 30 degrees and about 90 degrees around the rotational axis 54. The top segment extends between about 330 degrees and about 270 degrees around the rotational axis 54. The present disclosure, of course, is not limited to the foregoing values. For example, in other embodiments, each segment may extend about 180 degrees around the rotational axis 54, or otherwise.

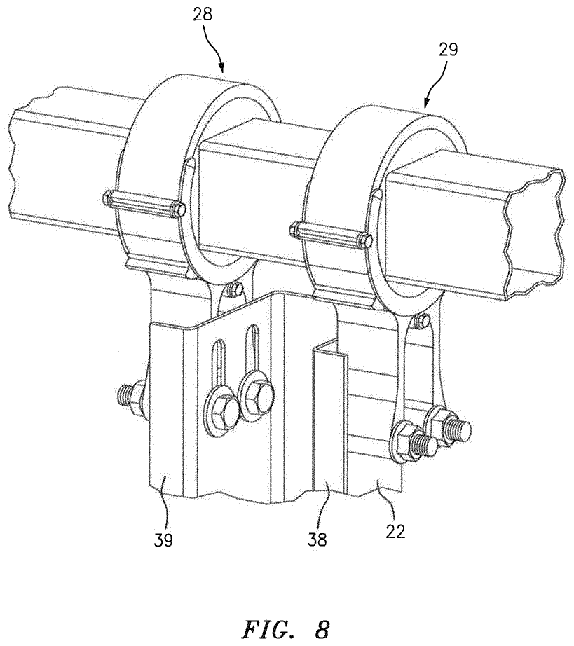

The collar mount 78 projects radially out (e.g., down) from collar base 76 (e.g., the bottom segment) to a distal mount end 82. The collar mount 78 may be formed integrally with the collar base 76 (e.g., the bottom segment), or attached thereto. The collar mount 78 includes a plurality of mounting apertures 84, 85 at the distal mount end 82. Each of these mounting apertures 84, 85 extends axially through the collar mount 78. The mounting apertures 84, 85 are configured to respectively receive fasteners 88, 89 (e.g., bolts or otherwise) for securing the collar mount 78 to a respective one of the stationary structural members 22, 24 as shown in FIGS. 7 and 8. In particular, each fastener extends through a respective one of the mounting apertures in the collar mount and a respective one of the mounting apertures (e.g., slots) 84, 85 in the stationary structural member 22, 24. The fasteners may be positioned within the mounting apertures (e.g., slots) in the stationary structural member so as to adjust the vertical height or lateral position of the bearing assembly; e.g., in order to ensure the rotational axis is as straight-line and/or level as possible as the rotatable shaft passes through the bearing assemblies. The fasteners may then be tightened to clamp the collar mount 78 to the respective stationary structural member 22, 24.

The capture rings 68, 58 are secured to opposing axial sides of the collar base 76 using, for example, one or more fasteners (e.g., screws) 88-93. Each capture ring 68, 69 projects radially inward from the inner surface 78 of the collar base 76 and thereby overlaps an axial end of the bearing ring 66 to prevent that end from sliding out of the bore of the collar base.

FIG. 11 illustrates an exemplary embodiment of the drive mechanism 32. This drive mechanism includes a drive arm 98 and an actuator 100. The drive arm 98 is substantially axially aligned with the stationary structural member 22 along the rotational axis. A first end of the drive arm is secured to the rotatable shaft 26. Distal end flanges 38, 39 of the drive arm 98, for example, are clamped around the rotatable shaft 26 between two adjacent and proximate bearing assemblies 28, 29.

The actuator 100 is substantially axially aligned with the stationary structural member and the drive arm along the rotational axis. The actuator 100 is pivotally connected to the drive arm 98. More particularly, a first end of the actuator projects through an opening in the drive arm and is pivotally connected to and between two sides of the drive arm at its second end by a shaft; e.g., a threaded rod 102. The actuator is also connected to the stationary structural member 22; e.g., the center post. More particularly, an intermediate portion of the actuator 100 is pivotally connected to and between the first and second flanges 38, 39 of the stationary structural member 22. An end portion of the actuator 100 may project through an opening in the web of the stationary structural member to a second end of the actuator, where a motor 104 for actuating the actuator may be located. The intermediate portion of the actuator may be connected to the flanges 38, 39 by an actuator mount 106 clamped therearound, or with trunnion blocks welded to the actuator housing, and a shaft.

The actuator 100 may be a hydraulic piston actuator or a screw drive mechanism actuator. The actuator may thereby include a pushrod 107 and a base 108, where the push rod 107 projects out from and slides within and relative to the base. The pushrod 107 may be pivotally connected to the drive arm 98. The base 108 may be pivotally connected to the stationary structural member 22. Of course, the drive mechanism of the present disclosure is not limited to the foregoing exemplary actuator configuration or mounting scheme.

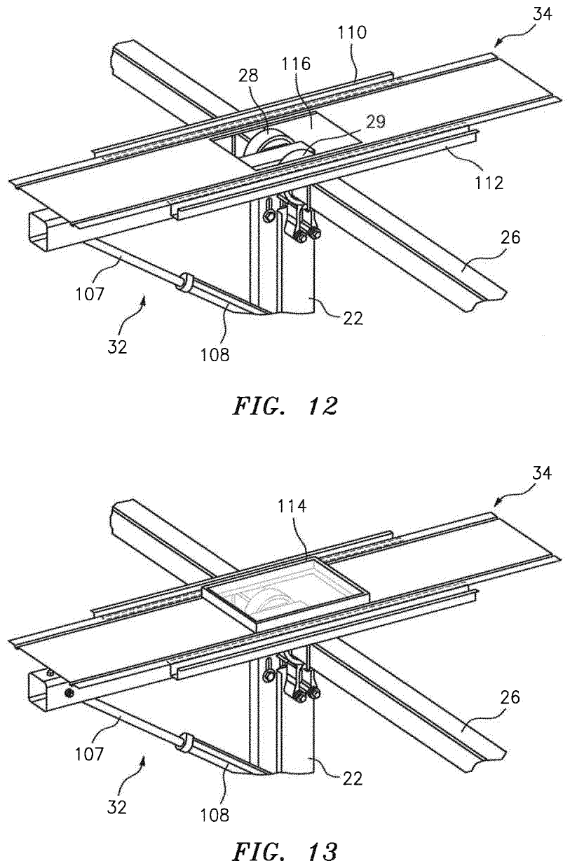

FIGS. 12 and 13 illustrate an exemplary embodiment of the wind break plate 34. This wind break plate 34 is mounted to the rotatable shaft 26. In particular, the wind break plate of FIGS. 12 and 13 is mounted to a pair of support (e.g., purlin) members 110, 112, which in turn are mounted to the rotatable shaft 26. The support members are located on opposing sides of the stationary structural member 22 and/or two respective bearing assemblies 28, 29 along the rotational axis. The wind break plate 34 is configured to at least partially cover the distal member end of the stationary structural member and the drive mechanism. The wind break plate may also provide a mounting surface for a solar panel 114, which is operable to provide power to the drive mechanism 32. The solar panel 114 may be nested with an opening 116 in the wind break plate 34 over the distal member end.

Referring again to FIG. 1, a pair of the solar panels 17, 18 are located adjacent to and on opposing sides of the wind break plate. The wind break plate may substantially close a lateral gap between the solar panels.

The solar panel installation of FIG. 1 includes a control system. This control system may include a single node controller, or a plurality of node controllers depending upon the specific configuration of the solar panel installation. For example, the control system may include a single node controller where the solar panel installation includes a single drive mechanism. Alternatively, the control system may include a plurality of node controllers where the solar panel installation includes multiple drive mechanisms and those mechanisms are divided into different nodes (of one or more mechanisms) with independent control. The control system may also include a master controller in signal communication (e.g., hardwired and/or wirelessly connected) with the one or more node controllers.

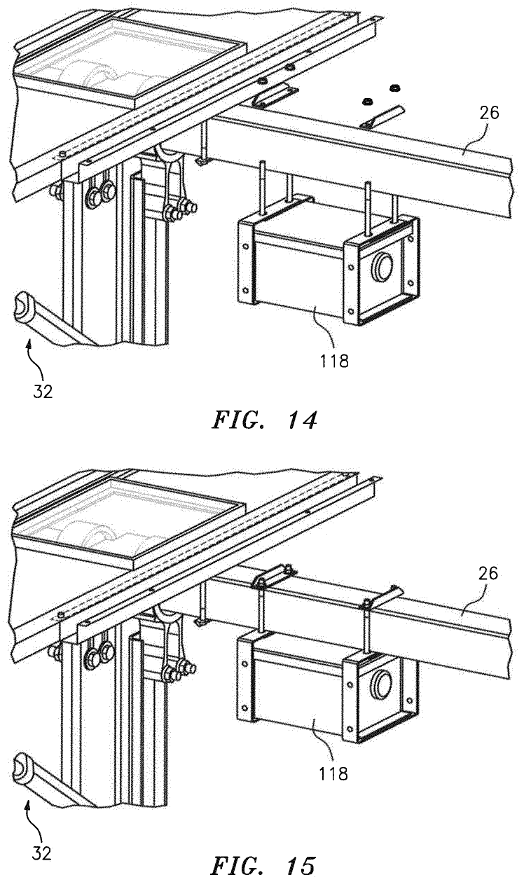

An exemplary embodiment of a node controller 118 is shown with the rotatable shaft 26 in FIGS. 14 and 15. This node controller 118 may include a processor, a tilt measuring device (e.g., a sensor), a clock, a memory, one or more motor drivers, and a communication device (e.g., a transceiver, an input port and/or an output port). The tilt measuring device is configured to measure the tilt of the solar panels, which may be measured directly or indirectly through the rotational position of the rotatable shaft 26. The memory may include one or more lookup tables. These lookup tables may be used by the processor to determine what tilt the solar panel array should be positioned at a certain time of day based on one or more of the following parameters: location; sun elevation and/or azimuth; row spacing; and slope for backtracking analysis. The motor drives are configured to command the motor for the actuator to turn and actuate the actuator until an appropriate solar panel tilt is obtained. The communication device is configured to provide communication between the node controller and another device; e.g., the master controller. A snow depth sensor may also be included with or connected to the node controller 118. This snow depth sensor is configured to provide data to the node controller, which can trigger a warning and/or an adjustment in operational tilt range.

The master controller may be configured to communicate wirelessly with one or more node controllers. The master controller is configured to synch up the node controller clocks to a master controller clock periodically (e.g., every day) to make sure all of the clocks are all at the exact same time so tilts are uniform. The master controller is also configured to receive information from the node controllers about time of day and tilt to see if any solar panels are not at proper tilt or are not running. The master controller may subsequently relay this data to another device such as a cell phone, or wireline the data to the cloud or customer communications network for service call notification and analysis.

The master controller may include or be connected to a wind speed sensor (e.g., an anemometer) configured to read wind speed. The master controller may monitor the wind speed and the tilt of the system as determined, for example, using a lookup table for the site. The master controller may calculate at what wind speed the system should move towards a stow position. The master controller may then broadcast control signals to the node controllers to move the solar panels toward their stow position in a certain increment in degrees of tilt. The master controller may then continue to monitor the windspeed, and if more adjustments are needed to move further towards full stow position due to increasing windspeed the master controller may send additional broadcast stow messages to the node controllers. By providing incremental partial stow messages and movements to match up tilt with windspeed and only change the tilt to that closest to optimal based on monitored windspeed, the solar panels may not need to be moved to the fully stowed position, battery drain may be minimized and/or the power output of the entire array may be maximized by reducing time that the solar panels are moved away from optimal power producing position in high speed wind conditions. Also, by having the stow position be at the fully retracted actuator position with panels facing west, positioning in the stow position may be optimized to be mostly in the afternoon hours when thunderstorms are prevalent, which increases the average stow windspeed dramatically, which again reduces battery usage and reduces any power loss from the array being moved out of optimal power producing tilt due to wind events.

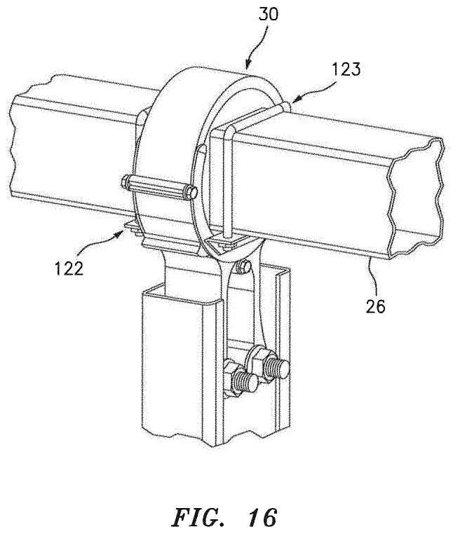

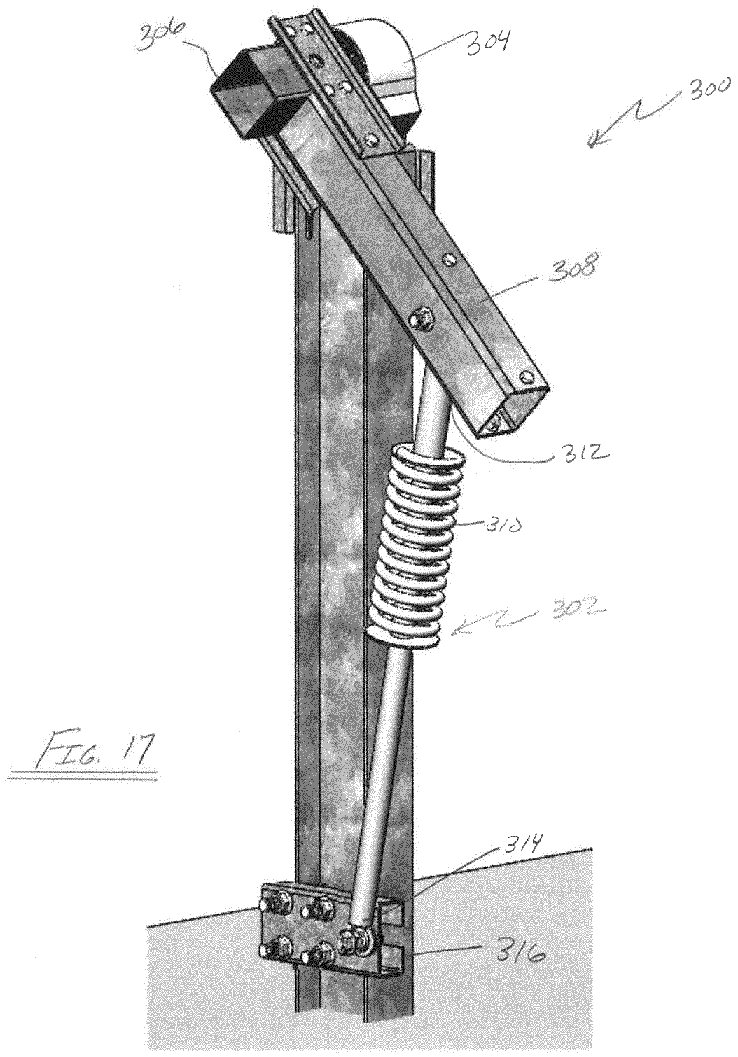

In some embodiments, the solar panel array may include one or more lateral capture devices 122, 123 as shown in FIG. 16. In an exemplary embodiment, the lateral capture devices are configured as U-bolts with associated clamping plates (e.g., brackets). The lateral capture devices may be put on either side (or just one side) of the bearing, adjacent the bearing, and clamped onto the rotatable shaft. The clamped lateral capture devices may thereby prevent lateral movement of the rotatable shaft 26 relative to the bearing. In this manner, the rotatable shaft may remain properly positioned even where the solar panel installation is on sloped ground, there is a seismic event, the wind pushes against the solar panels, etc.

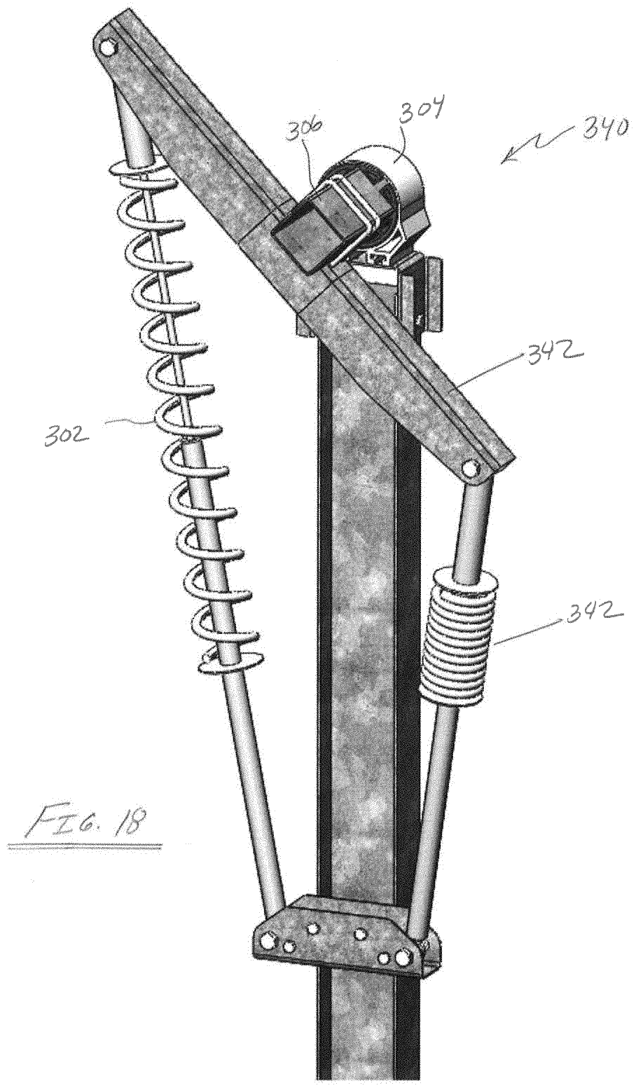

FIG. 17 illustrates a portion of an alternative embodiment drive structure 300 that includes a damper 302. As shown in FIG. 17 a bearing assembly 304 secures rotatable shaft 306, which is connected to an arm 308. The damper 302 may include a shock absorber having a piston and piston rod and a cooperating spring 310. A first end 312 of the damper is connected to the arm 308 while a second end 314 of the damper is connected to a post 316. The shock absorber and spring prevents the tracker from over rotation and from moving back and forward too much, which allows trackers to be longer and handle higher wind speeds.

FIG. 18 illustrates a portion of yet another alternative embodiment drive structure 340 that includes a damper 302 and second damper 342. The bearing assembly 304 secures rotatable shaft 306, which is connected to an arm 344. The damper 302 is connected to a first end of the arm 344, and the second damper 342 is connected to a second end of the arm 344. This embodiment also prevents over rotation and increases the stability of the tracker in high winds.

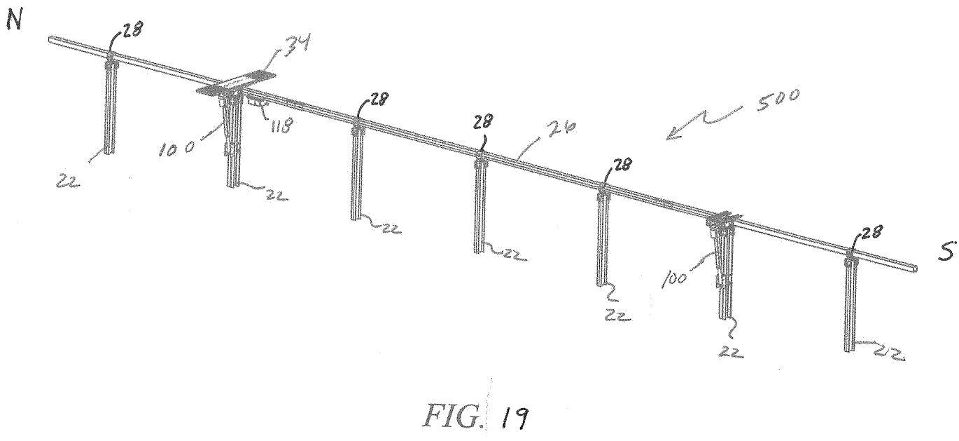

FIG. 19 illustrates a dual motor single axis solar tracker assembly 500. The rotatable shaft 26 of the single axis tracker is rotatably secured to a plurality of the bearing structures 28 and driven by dual drive assemblies 100. In this embodiment the single axis solar tracker includes two drive assemblies/motors per tracker table. Two drive assemblies/motors is preferable in that it addresses several serviceability and structural design concerns for the tracker, while adding minimal additional cost to the system.

In one embodiment the number of motors along the tracker table is two and the optimal location for each motor is between about 16% and 25% of the tracker table length from either end North and South. This location balances three (3) design requirements: rotational stress in the shaft, rotational twist in the shaft, and increase of modal frequency of the shaft.

A primary purpose of the rotating shaft is to support the photovoltaic solar modules through any climatic event. Wind and snow loads for given project locations can be calculated using figures and formulas provided in the building code. The rotatable shaft 26 of the single axis tracker is periodically supported by bearings which in turn are supported by foundation elements (i.e., driven posts). These bearings provide vertical support but may offer no rotational support. All torque applied by wind or snow to the photovoltaic modules is transferred to the rotatable shaft. This accumulates along the length of the rotatable shaft and is maximum immediately adjacent to the motor. Based on these mechanics, if the climatic loads were perfectly uniform, the ideal location for two motors would be at the quarter points along the table length (i.e., one motor 25% of the table length away from each end). However, the wind load, which is typically the governing force in the tracker table design, is not uniform. For the vast majority of the tracker tables in a utility scale solar power plant, the wind load at the exposed end of the tracker is greater than in the middle. This is due to the sheltering effect the photovoltaic modules on the edge of the array have on those in the middle. The ratio of the wind loads on the exposed end of the tracker versus the middle can exceed 2:1. Based on these mechanics, a preferred location for the motors would be less than ⅙ of the tracker length from the end (e.g., one motor approximately 16% from each end).

An advantage of single axis solar trackers is that they orient the photovoltaic modules to optimize the angle between the modules and the sun. As such, the tilt angle of the shaft of the tracker, and therefore the supported photovoltaic modules, is of great importance. This angle can be affected by multiple things including manufacturing tolerances of the shaft, installation tolerances of the shaft, and self weight of the photovoltaic modules which causes rotational deflection in the shaft. As the tilt angle at the motors is controlled, the farther away from the motor one goes along the shaft, the greater the possible variance in the tilt angle. In the case of self weight induced rotational deflection, the change in tilt angle is a function of the square of the distance along the shaft between the motor and the point in question. As such, one exemplary embodiment calls for the reduction/minimization of the length between any point on the tracker table and a motor. This would be theoretically optimized with the motors being at the quarter points along the table length (i.e., one motor 25% of the table length away from each end). However, as the tilt angle at both motors is controlled, any twist in the center span of the shaft between the two motors due to manufacturing tolerance of the shaft or installation tolerance of the shaft is reduced meaning that this tolerance is present when the motor is installed but removed once it is rotated to the control angle. This reduction in manufacturing and installation tolerance is not possible on the end spans. As such it is preferable to make the end spans shorter than 25% of the table length and grow the center span accordingly.

A major structural design concern for single axis solar trackers is aeroelastic instability. Aeroelastic instability, (i.e., torsional divergence or more commonly “galloping”) is a result of vortices generated along (and later thrown off from) the leading edge of a single axis solar tracker. This phenomenon occurs strongest at shallow tilt angles between the solar modules and the horizontal. The first vortex pulls the tracker upward, away from the flat position. This winds the shaft like a torsional spring. At some point the resisting torsion in the tube overcomes the wind load and the sudden release of the vortex on the top of the modules leads to a rapid loss of torque. The tracker then springs back past flat, and a vortex forms on the underside of the leading edge. This pulls the leading edge downward, until the second vortex is released, at which point the tracker twists back up above flat, and the process continues. If the wind speed is high enough (i.e., there is enough input energy into the system) the system becomes unstable, with the amplitude increasing each time, until the tracker structurally fails.

Aeroelastic instability is highly sensitive to the modal frequencies of the shaft, particularly in the rotational direction. The frequency is roughly proportional to the inverse of the square of the unsupported length (keep in mind that while the bearings along the length of the shaft provide vertical support, they do not provide rotational support). However, the critical wind speed at which aeroelastic instability occurs is a function of the square root of the frequency.

As stated above, the ideal location for the motors is roughly 16% from either end of the tracker table from the perspective of balancing wind load and torsional stresses on the shaft, and less than 25% from either end of the tracker table from the perspective of optimizing the tilt angle of the photovoltaic modules. Using an example location of 20% from either end of the tracker table for the purposes of this frequency analysis, we see that the modal frequency of the shaft will increase by a factor of 2.78×, resulting in an increase in critical wind speed for aeroelastic instability of 60% when compared to a tracker with a single motor. This will yield a critical wind speed on the order of 50 mph which is beyond the requirements of all utility scale solar power plant owners encountered by the inventor to date.

Adding additional motors beyond two would have diminishing returns. Providing two points of support allows for accuracy well within the tolerances of recognized international standards, such as IEC 62817, and prevents aeroelastic instability such that operational uptimes are in excess of 99%. Adding additional support points to the shaft will not improve performance metrics such that they will have a meaningful impact on the power production of utility scale solar power plants.

While various embodiments of the present invention have been disclosed, it will be apparent to those of ordinary skill in the art that many more embodiments and implementations are possible within the scope of the invention. For example, the present invention as described herein includes several aspects and embodiments that include particular features. Although these features may be described individually, it is within the scope of the present invention that some or all of these features may be combined with any one of the aspects and remain within the scope of the invention. Accordingly, the present invention is not to be restricted except in light of the attached claims and their equivalents.

What is claimed is:

1. An assembly for a solar panel installation, the assembly comprising:
a plurality of stationary structural members each having a length that extends longitudinally to an associated distal member end;
a rotatable shaft having a rotatable axis and a rotatable shaft length L extending from a north end to a south end, wherein the rotatable shaft is rotatably connected to the plurality of stationary structural members at the distal member ends by one or more bearings;
a first drive mechanism configured to rotate the rotatable shaft about the rotatable axis at a first of the plurality of stationary structural members, the first drive mechanism mounted to the first of the plurality of stationary structural members; and
a second drive mechanism configured to rotate the rotatable shaft about the rotatable axis at a second of the plurality of stational structural members, the second drive mechanism mounted to the second of the plurality of stationary structural members.

2. The assembly of claim 1, further comprising:
a first wind break plate mounted to the rotatable shaft, the first wind break plate configured to at least partially cover the distal member end of the first of the plurality of stationary members and the first drive mechanism; and
a first wind break plate mounted to the rotatable shaft, the second wind break plate configured to at least partially cover the distal member end of the second of the plurality of stationary members and the second drive mechanism.

3. The assembly of claim 1, where the first drive mechanism is mounted about 16% of the rotatable shaft length L from the north end.

4. The assembly of claim 1, where the second drive mechanism is mounted about 16% of the rotatable shaft length L from the south end.

5. The assembly of claim 1, where the first drive mechanism is mounted less than about 16% of the rotatable shaft length L from the north end.

6. The assembly of claim 5, where the second drive mechanism is mounted less than about 16% of the rotatable shaft length L from the south end.

7. The assembly of claim 1, where the first drive mechanism is mounted about 25% of the rotatable shaft length L from the north end.

8. The assembly of claim 7, where the second drive mechanism is mounted about 25% of the rotatable shaft length L from the south end.

9. The assembly of claim 1, where the first drive mechanism is mounted less than about 25% of the rotatable shaft length L from the north end.

10. The assembly of claim 9, where the second drive mechanism is mounted less than about 16% of the rotatable shaft length L from the south end.

11. The assembly of claim 1, where the first drive mechanism is mounted about 20% of the rotatable shaft length L from the north end.

12. The assembly of claim 11, where the second drive mechanism is mounted about 20% of the rotatable shaft length L from the south end.

13. The assembly of claim 1, where the first drive mechanism is mounted less than about 20% of the rotatable shaft length L from the north end.

14. The assembly of claim 13, where the second drive mechanism is mounted less than about 16% of the rotatable shaft length L from the south end.

15. The assembly of claim 1, further comprising a pair of purlin members, wherein the purlin members are located on opposing sides of the first of the plurality of stationary structural members along the rotational axis, and wherein the purlin members mount the first wind break plate to the rotatable shaft.

16. The assembly of claim 1, further comprising a pair of solar panels, wherein the solar panels are located adjacent to the first wind break plate and mounted to the rotatable shaft, and wherein the wind first break plate substantially closes a gap between the solar panels.

17. The assembly of claim 1, wherein the solar panel is operable to provide power to the first drive mechanism.

18. The assembly of claim 1, wherein the solar panel is nested with an opening in the first wind break plate over the distal member end of the first of the plurality of stational structural members.

19. An assembly for a solar panel installation, the assembly comprising:
a plurality of stationary structural members each having a length that extends longitudinally to a distal member end, each of the plurality of the stationary structural members comprising a first flange, a second flange and a web extending between the first flange and the second flange;
a rotatable shaft extending along a rotatable axis and including rotatable shaft length L extending from a north end to a south end, wherein the rotatable shaft is rotatably connected to each of the plurality of stationary structural members at the distal member ends by one or more bearings;
a first drive arm secured to the rotatable shaft and aligned with a first of the stationary structural members along the rotational axis;
a first actuator aligned with the first of the stationary structural members and the first drive arm along the rotational axis, the first actuator comprising a first actuator base and a first pushrod projecting out of the first actuator base, wherein the first actuator base is pivotally connected to and between the first and the second flanges with the first of the stationary structural members, wherein the first pushrod is pivotally connected to and between two mounts of the first drive arm, and wherein the first pushrod is configured to move into and out of the first actuator base in order to move the first drive arm relative to the first of the stationary structural members and thereby rotate the rotatable shaft about the rotational axis;
a first second arm secured to the rotatable shaft and aligned with a second of the stationary structural members along the rotational axis; and
a second actuator aligned with the second of the stationary structural members and the second drive arm along the rotational axis, the second actuator comprising a second actuator base and a second pushrod projecting out of the second actuator base, wherein the second actuator base is pivotally connected to and between the first and the second flanges with the second of the stationary structural members, wherein the second pushrod is pivotally connected to and between two mounts of the second drive arm, and wherein the second pushrod is configured to move into and out of the second actuator base in order to move the second drive arm relative to the second of the stationary structural members and thereby rotate the rotatable shaft about the rotational axis.

20. An assembly of claim 19, where the first actuator is mounted about 12-29% of the rotatable shaft length L from the north end of the rotatable shaft, and where the second actuator is mounted about 12-29% of the rotatable shaft length L from the south end of the rotatable shaft.

21. An assembly of claim 19, where the first actuator is mounted about 12-20% of the rotatable shaft length L from the north end of the rotatable shaft, and where the second actuator is mounted about 12-20% of the rotatable shaft length L from the south end of the rotatable shaft.
